(19) United States
(12) Patent Application Publication
(10) Pub. No.: US 2011/0020613 A1
(43) Pub. Date: Jan. 27, 2011

(54) INJECTION-MOLDED PRODUCT HAVING MULTILAYER PATTERN AND METHOD OF FABRICATING THE SAME

(75) Inventors: Jong-Hwa KIM, Gyeongsangbuk-do (KR); Yong-Pil LIM, Gyeongsangbuk-do (KR); Jong-Bae PARK, Gyeongsangbuk-do (KR); Jin-Ho KIM, Gyeongsangbuk-do (KR); Ho-Kyung MOON, Gyeonggi-do (KR); Young-Jik LEE, Gyeongsangbuk-do (KR); Hak-Ju KIM, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/839,474

(22) Filed: Jul. 20, 2010

(30) Foreign Application Priority Data
Jul. 21, 2009 (KR) 10-2009-0066370

(51) Int. Cl. B32B 3/02; B05D 5/00; B05D 3/00

(52) U.S. Cl. 428/187; 427/256; 427/307

(57) ABSTRACT

An injection-molded product having a multilayer pattern, includes: a main layer formed on the injection-molded product, the main layer either protruding from or being recessed on a surface of the injection-molded layer, thereby forming a base pattern; a dual-level layer formed on the main layer, the dual-layer either protruding from or being recessed on the main layer, thereby providing a cubic effect and a gripping sense for the main layer; a deposition layer deposited on the surface of the injection-molded product so as to implement a color sense for the injection-molded product; and a clear coating applied to the deposition layer so as to protect the surface of the injection-molded product and the deposition layer

### CLAIM OF PRIORITY

This application claims the priority under 35 U.S.C. §119(a) of an application entitled “Injection-Molded Product Having Multilayer Pattern And Method Of Fabricating The Same” filed in the Korean Intellectual Property Office on Jul. 21, 2009 and assigned Serial No. 10-2009-0066370, the contents of which are hereby incorporated by reference.

### BACKGROUND OF THE INVENTION

1. Field of the Invention

The present invention relates to an injection-molded product having a multilayer pattern and a method of fabricating the same, and more particularly to an injection-molded product having a multilayer pattern, and a method of fabricating such an injection-molded product.

2. Description of the Related Art

In general, an injection-molded product refers to a synthetic resin product fabricated in a shape corresponding to a cavity in a mold by pouring molten resin into the mold. Since injection-molded products can be easily mass-produced, they are widely used for producing articles in daily use or casings for household appliances or electronic appliances. In particular, injection-molded products are used in cosmetic cases, and portable terminals, such as game machines and mobile phones, or the like. These type of portable articles are treated as a kind of fashionable items for many consumers. According to this trend portable terminal users occasionally buy a separate portable pouch, or decorate a portable terminal by enclosing it with a casing that mounts the portable terminal.

According to various demands and preferences of many users, efforts for diversifying appearances of housings for portable articles have been made. For example, from a simple measure that diversifies colors of products, colors are applied in such a manner that the colors are gradually changed in one product or a pattern is engraved on a surface of such a product so as to provide a visual effect.

Meanwhile, engraving a pattern on a surface of an injection-molded product has been executed through a process of forming a separate film, or a printing process. By engraving a pattern in this manner, it is possible to provide a new visual effect on the appearance of portable goods. However, since a conventional method, that attaches a separate film to or prints a pattern on an outer surface of an injection film, merely provides a planar visual effect, there is a limit in satisfying users' various tastes.

Therefore, what is needed is an improved way of providing an injection-molded product and its method of fabricating the same.

### SUMMARY OF THE INVENTION

Accordingly, the present invention has been made to solve the above-mentioned problems occurring in the prior art and provides additional advantages, by providing an injection-molded product having a multilayer pattern and a method of fabricating the same, wherein the multilayer pattern allows the appearance of an injection-molded product, such as a cosmetic case or a case for a portable product, e.g. a portable terminal, to be provided with various visual effects.

Also, the present invention provides an injection-molded product having a multilayer pattern and a method of fabricating the same, wherein the injection-molded product has a main layer and a dual-level layer, and various metal materials are deposited on a surface of the injection-molded product so as to provide a cubic effect and various color senses.

In accordance with an aspect of the present invention, the multilayer pattern is formed on a surface of the injection-molded product in such a manner that the pattern has a plurality of protrusions with various heights and a plurality of recesses with various depths so as to diversify the appearance design of the product and to provide a cubic effect and a gripping sense, wherein various metal materials and other coatings are formed on the surface of the product in such a manner that more diversified colors can be implemented on the product and various color senses can be implemented on the multilayer pattern according to the reflection of light.

In accordance with an aspect of the present invention, an injection-molded product having a multilayer pattern includes: a main layer formed on the injection-molded product, the main layer either protruding from or being recessed on a surface of the injection-molded layer, thereby forming a base pattern; a dual-level layer formed on the main layer, the dual-layer either protruding from or being recessed on the main layer, thereby providing a cubic effect and a gripping sense for the main layer; a deposition layer deposited on the surface of the injection-molded product so as to implement a color sense for the injection-molded product; and a clear coating applied to the deposition layer so as to protect the surface of the injection-molded product and the deposition layer.

In accordance with another aspect of the present invention, a method for fabricating an injection-molded product having a multilayer pattern includes: forming a main layer and a dual-level layer, the main layer either protruding from or being recessed on a surface of the injection-molded layer, thereby forming a base pattern, and the dual-level layer being formed on the top of the main layer in such a manner that the dual-level layer either protrudes from or is recessed on the main layer, thereby providing a cubic effect and a gripping sense for the main layer; forming a deposition layer by depositing a metal material on the surface of the injection-molded product; and applying a clear coating to the top of the deposition layer, the clear coating being adapted to protect the surface of the injection-molded product and the deposition layer.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view showing a mold used for molding an injection-molded product having a multilayer pattern in accordance with an embodiment of the present invention;

FIGS. 2a to 2c are views, each of which shows a state in which a dual-level layer is formed on a main layer of an injection-molded product having a multilayer pattern in accordance with an embodiment of the present invention;

FIGS. 3 to 5 are views, each of which shows a state in which a deposition layer and a clear coating are provided on a surface of an injection-molded product having a multilayer pattern in accordance with an embodiment of the present invention;

FIG. 6 is a view showing a state in which a base coating is formed between a deposition layer and a clear coating on an injection-molded product having a multilayer pattern in accordance with an embodiment of the present invention;

FIG. 7 is a view showing a state in which on an injection-molded product having a multilayer pattern in accordance with an embodiment of the present invention, a surface of the injection-molded product is pre-processed before depositing a deposition layer;

FIG. 8 is a view showing a state in which on an injection-molded product having a multilayer pattern in accordance with an embodiment of the present invention, base coating is formed between a deposition layer and a clear coating, and a surface of the injection-molded product is pre-processed before depositing a deposition layer;

FIG. 9 is a view showing a state in which on an injection-molded product having a multilayer pattern in accordance with an embodiment of the present invention, a main layer and a dual-level layer are formed;

FIGS. 10 to 13 are views, each of which shows a method of fabricating an injection-molded product having a multilayer pattern in accordance with an embodiment of the present invention.

### DETAILED DESCRIPTION OF THE INVENTION

Hereinafter, exemplary embodiments of the present invention will be described with reference to the accompanying drawings. In the following description, various specific definitions found in the following description are provided only to help general understanding of the present invention, and it is apparent to those skilled in the art that the present invention can be implemented without such definitions.

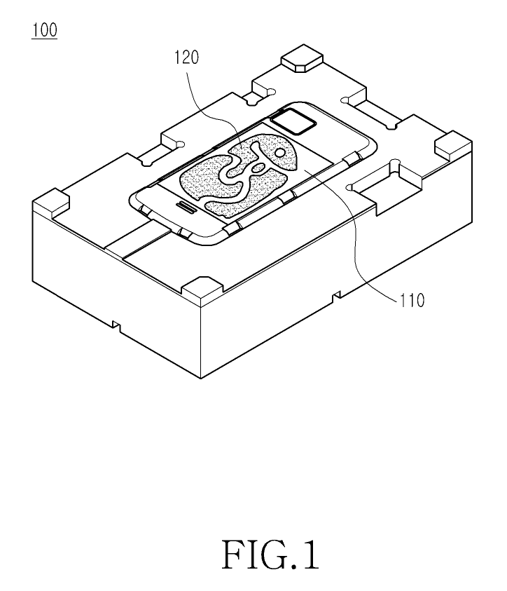

Referring to FIGS. 1 to 9, an injection-molded product 110 having a multilayer pattern includes a main layer 120, a dual-level layer 130, a deposition layer 140, and a clear coating 150. The main layer 120 is formed on a surface of the injection-molded product 110 in such a manner that the main layer 120 either protrudes from or is recessed on a surface of the injection-molded product 110 so as to form a base pattern. The dual-level layer 130 is formed on the main layer 120 in such a manner that the dual-level layer 130 either variously protrudes from or is recessed on the main layer 120 so as to provide a cubic effect and a gripping sense for the main layer 120. The deposition layer 140 is deposited on the surface of the injection-molded product 110 so as to implement various quality and color senses. The clear coating 150 is applied to the top of the deposition layer 140 so as to protect the surface of the injection-molded product and the deposition layer 140.

As shown in FIGS. 1, 5 and 9, the main layer 120 is formed on the surface of the injection-molded product 110, using at least one of NC discharge, etching, laser, and sand paper. The dual-level layer 130 is formed on the top of the main layer 120, using at least one of NC discharge, etching, laser, and sand paper.

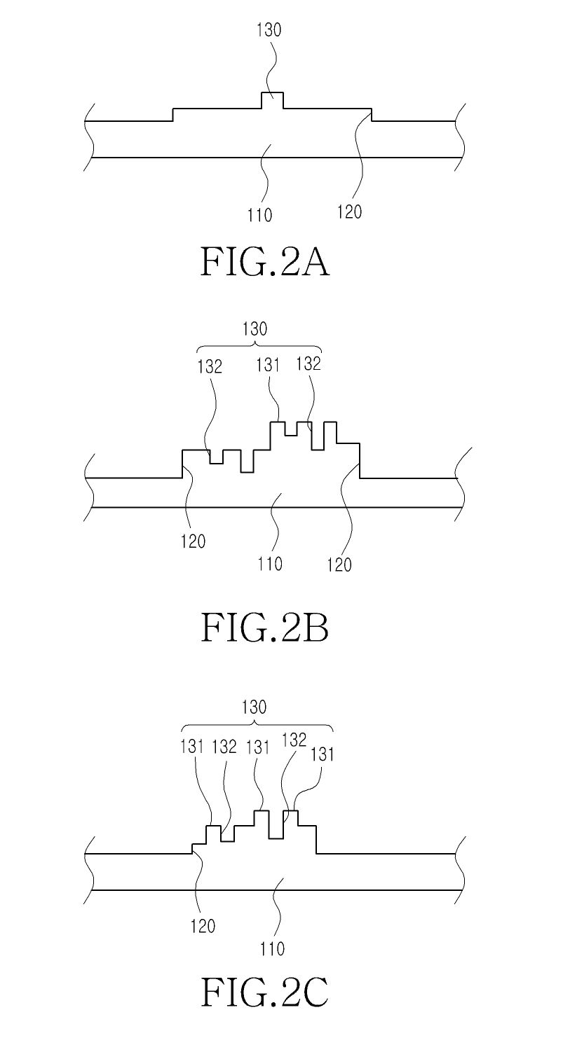

As shown in FIGS. 2a to 2c, the dual-level layer 130 includes a protrusion layer part 131 and a recess layer part 132. The protrusion layer part 131 includes one or more protrusions protruding from the main layer 120, and the recess layer part 132 includes one or more recesses formed on the top of the main layer 120 with different depths.

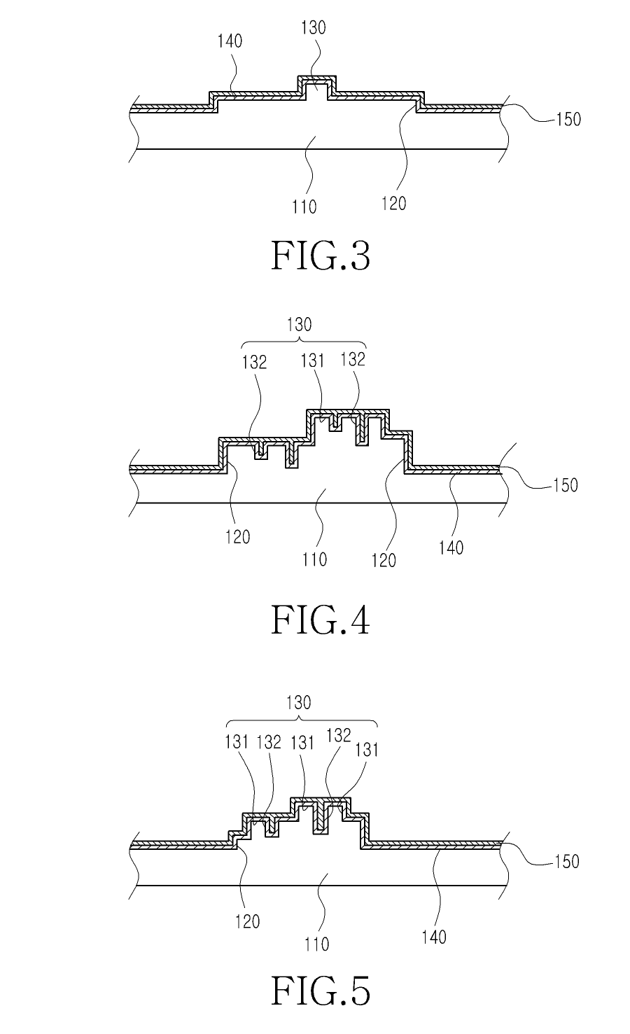

As shown in FIGS. 3 to 8, the deposition layer 140 includes a metal film 140, which is formed by depositing one or more metal materials on the surface of the injection-molded product 110. In particular, the metal film 140 is formed by depositing at least one of tin (Sn), silicon (Si), titanium (Ti), aluminum (Al), chrome (Cr), and stainless steel (SUS) on the surface of the injection-molded product 110 at a thickness in the range of 0.01 to 0.1 μm.

As shown in FIG. 3, the clear coating 150 is applied to the top of the deposition layer 140 at a thickness in the range of 15 to 20 μm.

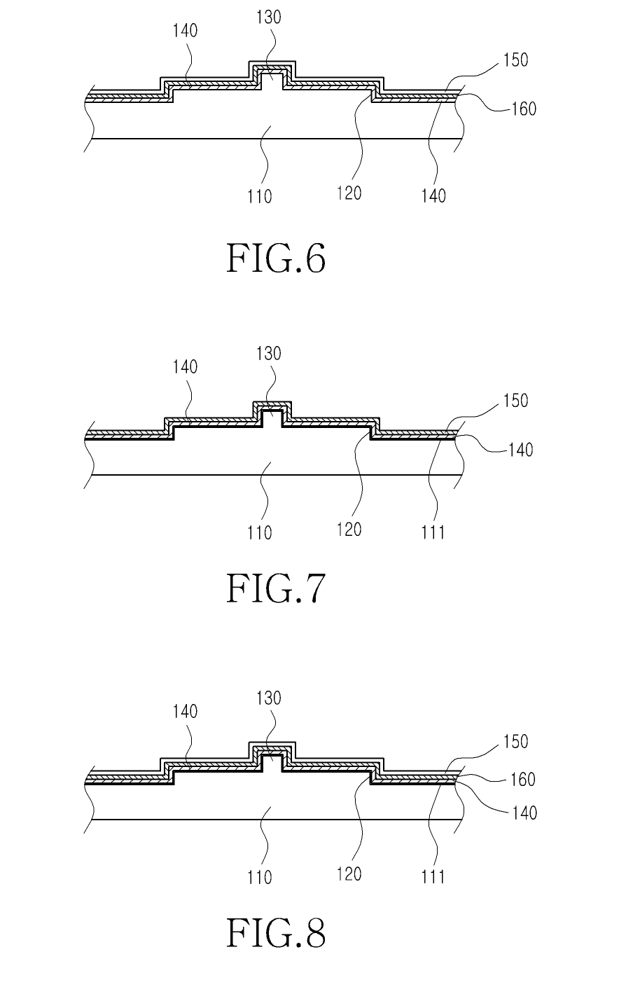

As shown in FIG. 6, a base coating 160 is interposed between the deposition layer 140 and the clear coating 150 so as to increase the luminance of the deposition layer 140 and to provide a color sense for the deposition layer 140, wherein the base coating 160 is applied at a thickness in the rage of 5 to 15 μm. At this time, it is possible to form the base coating 160 from a color base coat so as to implement the color sense for the injection-molded product 110 or to provide a change depending on the color sense for the deposition layer 140. In addition, it is also possible to provide the base coating 160 prior to forming the clear coating 150 so as to form an additional hard protection film on the outer surface of the injection-molded product 110 and to strengthen the compatibility between the injection-molded product 110 and the clear coating 150.

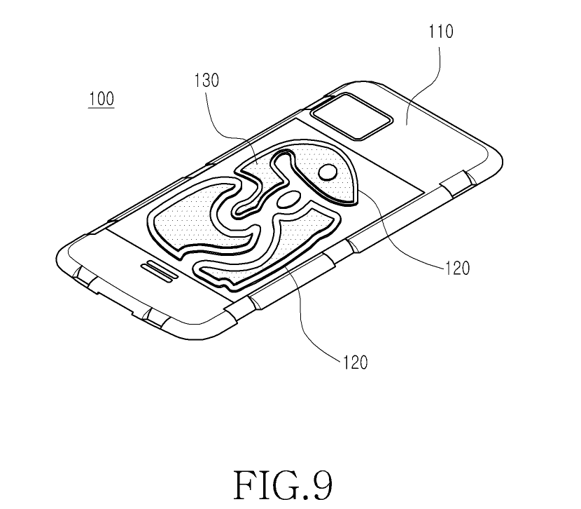

As shown in FIGS. 7 to 9, it is desired that the injection-molded product 110 is formed with a pre-processed surface part 111 formed by pre-processing the surface of the injection-molded product prior to depositing the metal film layer 140 so as to strengthen the compatibility between the injection-molded product 110 and the deposition layer 140, wherein an ion plate is preferably employed when pre-processing the surface of the injection-molded product 110 with at least one of nitrogen (N₂) gas, oxygen (O₂) gas, and argon (Ar) gas. It will be understood by a person skilled in the art that various processes know to those skilled in this art can be employed beyond employing the ion plate when pre-processing the surface of the injection-molded product 110.

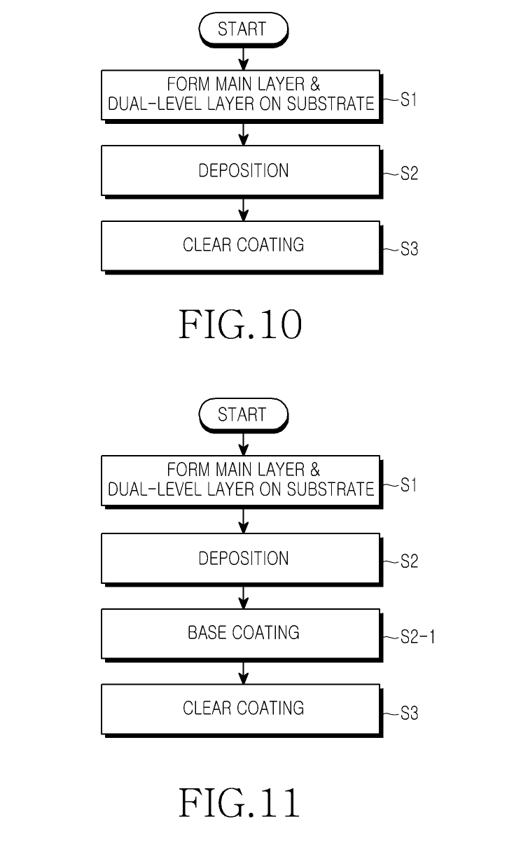

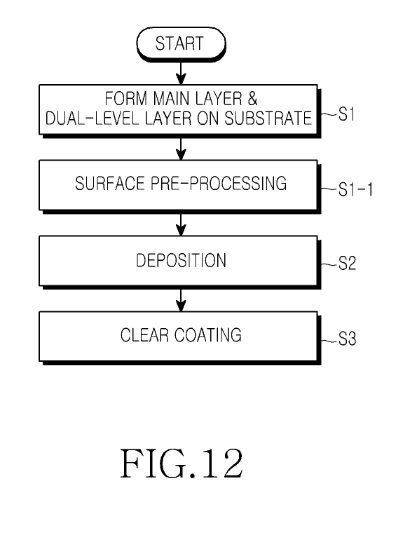

As shown in FIGS. 8 and 9, it is possible to apply a base coating 160 between the deposition layer 140 and the clear coating 150 at a thickness in the range of 5 to 15 in so as to increase the luminance of the deposition layer 140 and to provide a color sense for the deposition layer 140.

Hereinafter, the effects of an injection-molded product having a multilayer pattern in accordance with any of the above-mentioned embodiments will be described in more detail with reference to FIGS. 1 to 9.

As shown in FIGS. 1 to 9, on the front surface of an injection-molded product, various patterns may be formed by the main layer 120 and the dual-level layer 130. The main layer 120 and the dual-level layer 130 may be formed on the surface of the injection-molded product 110, using any of NC discharge, etching, laser, and sand paper, thereby forming various patterns on the surface of the injection-molded product. The main layer 120 forms stepped layers on the front surface of the injection-molded product 110 in such a manner that the main layer is recessed on and protrudes from the front surface, wherein the main layer forms a base pattern for a pattern formed on the injection-molded product 110. The dual-level layer 130 includes a protrusion layer part 131 and a recess layer part 132, which provide a cubic effect and a gripping sense to the main layer 120. The protrusion layer part 131 includes one or more protrusions protruding from the top of the main layer 120, and the recess layer part 132 includes one or more recesses formed on the top of the main layer 120 with one or more different depths. In addition, the recess layer part 132 may include one or more recesses formed on the top of the main layer 120 with one or more predetermined different depths, or may includes one or more recesses formed on the top of the protrusion layer part 131 with one or more predetermined different depths.

Referring to FIGS. 3 to 5, on the surface of the injection-molded product 110 formed with the main layer 120 and the dual-level layer 130, it is possible to deposit at least one metal material selected from tin (Sn), silicon (Si), titanium (Ti), aluminum (Al), chrome (Cr), and stainless steel (SUS) so as to form a metal film 140. The metal film 40 is deposited at a thickness, preferably in the range of 0.01 to 0.1 μm on the surface of the injection-molded product 110, and various colors can be implemented on the injection-molded product 110 depending the metal material(s) deposited on the surface thereof. The metal film 140 may be deposited on the surface of the injection-molded product 110 through an inline deposition process, a sputtering process, or other various deposition processes known to those skilled in this art, wherein according to the inline deposition process, a carrier equipped with the injection-molded product 110 is transferred to the interiors of a plurality of vacuum chambers for executing deposition. When the inline deposition process or the sputtering process is employed, the initial vacuum level of the vacuum chambers is preferably about 1.8×10⁻³ Torr. In addition, the clear coating 150 is applied to the top of the metal film 140. The clear coating 150 forms a hard protection film for protecting the surface of the injection-molded product 110, and the metal film 140 applied to the surface of the injection-molded product 110. The clear coating 150 is applied to the top of the deposition layer 140, wherein a difference in applied thickness may be caused depending on the heights of the protrusions of the protrusion layer part 131, and the depths of the recesses of the recess layer part 132. In addition, depending on the base coating 160 (to be described later), and the color sense of the base coating 160, the color sense of the deposition layer 140 deposited on the top of the injection-molded product will be changed. Accordingly, a difference in applied thickness will be caused in the base coating 160 and the clear coating 150 applied to the top of the base coating 160 depending on whether they are applied to the main layer 120 or the dual-level layer 130. Due to this effect, if sunlight or other light is illuminated to the surface of the injection-molded product 110, a difference in reflecting level is caused on the surface of the injection-molded product 110, depending on the difference in height and the difference in applied thickness, whereby various colors are visualized on the surface of the injection-molded product 110.

As shown in FIGS. 6 and 8, it is also possible to additionally form the base coating 160 on the injection-molded product 110 coated with the metal film 140. The base coating 160 is preferably a base coat selected from those having a color sense with a color tone, wherein the base coating 160 is provided so as to allow quality and color senses of the surface of the injection-molded product 110 to be expressed more variously. Furthermore, it is possible to provide the base coating 160 so as to form an additional hard protection film so as to strengthen the compatibility between the injection-molded product 110 and the clear coating 150.

In addition, as shown in FIGS. 7 and 8, it is also possible to pre-process the surface of the injection-molded product 110 prior to depositing the metal film 140 so as to form the pre-processed surface part 111. The pre-processed surface part 111 is formed by activating at least one of ionized nitrogen (N2) gas, oxygen (O2) gas, and argon (Ar) gas on an ion plate, thereby pre-processing the surface of the injection-molded product 110. On the injection-molded product 110, the metal film 140 is deposited on the top of the pre-processed surface part 111 injection-molded product 110, and the clear coating 150 is applied to the top of the metal film 140. The clear coating 150 is formed by applying a coating liquid containing acryl resin as a main component to the surface of the injection-molded product 150, thereby forming a hard protection film which is transparent and glossy. Therefore, by forming the clear coating 150 on the surface of the injection-molded product 110, the surface of the injection-molded product 110 can be protected and various color senses can be expressed by allowing colors to be reflected by light.

Therefore, as shown in FIGS. 5 to 8, by forming the main layer 120 and the dual-level layer 130 on the top of the injection-molded product 110, and applying the deposition layer 140 and the clear coating 150 to the top of the main layer 120 and the dual-level layer 130, it is possible to provide a cubic effect on the surface of the injection-molded product 110. In addition, depending on whether the pre-processed surface part 111 is formed or not on the surface of the injection-molded surface of the injection-molded product 110 and whether the base coating 160 is additionally applied between the deposition layer 140 and the clear coating 150, it is possible to provide a cubic effect and various color senses.

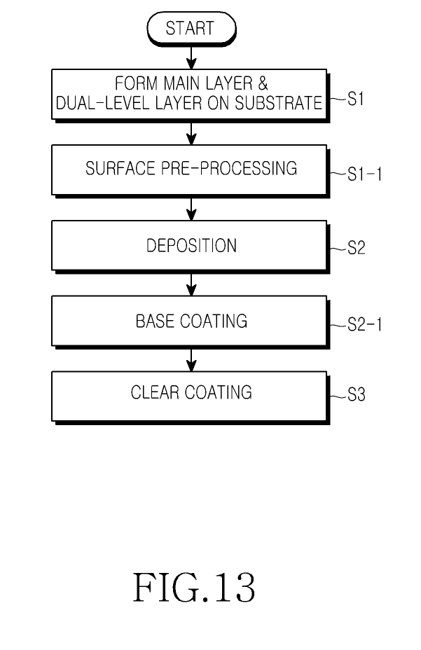

Now, several processes for fabricating an injection-molded product having any of multilayer patterns formed in accordance with above-mentioned embodiments of the present and having the above-mentioned structures will be described in more detail with reference to FIGS. 10 to 13. Since the constructions and acting effects for injection-molded products with the above-mentioned multilayer patterns are described above, repetitive descriptions will be omitted in the following description to avoid redundancy.

As shown in FIGS. 2a to 2c and 10, a method of fabricating an injection-molded product having a multilayer pattern forms a main layer 120 protruding from or being recessed on a surface of the injection-molded product 110, thereby forming a base pattern, and a dual-level layer 130 having at least one layer on the main layer 120 so as to provide a cubic effect to the main layer 120 (S1).

The main layer 120 is formed on the surface of the injection-molded product, using at least one of NC discharge, etching, laser, and sand paper, and the dual-level layer 130 is formed on the surface of the main layer 120, using at least one of NC discharge, etching, laser, and sand paper. The dual-level layer 130 includes a protrusion layer part 131 having one or more protrusions protruding from the main layer 120, and a recess layer part 132 having one or more recesses formed on the main layer 120 with different depths.

As shown in FIGS. 3 to 6 and 10, a metal material is deposited on the surface of the injection-molded product 110 obtained from the step S1, thereby forming a deposition layer 140 (S2).

The deposition layer 140 includes a metal film 140, wherein the metal film 140 is formed by depositing a metal material containing at least one of tin (Sn), silicon (Si), titanium (Ti), aluminum (Al), chrome (Cr), and stainless steel (SUS) on the surface of the injection-molded product 110. Preferably, the metal film 140 is deposited at a thickness in the range of 0.01 to 0.1 μm on the surface of the injection-molded product 110.

As shown in FIGS. 3 to 8 and 10, on the top of the deposition layer 140 obtained from the step S2, a clear coating 150 is coated at a thickness in the range of 15 to 20 μn (S3).

In addition, as shown in FIGS. 6 and 11, the inventive method further includes a step of forming a base coating 160 on the top of the deposition layer 140 after depositing the deposition layer 140, so as to increase the luminescence of the deposition layer 140 and to provide the color sense of the deposition layer 140 (S2-1).

In addition, as shown in FIGS. 7 and 12, prior to depositing the metal film 140 on the injection-molded product 110 at the step S2, the inventive method may further include a step of pre-processing the surface of the injection-molded product 110, thereby forming a pre-processed surface part 111, wherein the surface of the injection-molded product 110 is pre-processed by at least one of nitrogen (N2) gas, oxygen gas (O2), and argon gas (Ar) which are activated by an ion plate (S1-1).

In addition, as shown in FIGS. 8 and 13, the inventive method may further include a step of forming the pre-processed surface part 113 prior to depositing the deposition layer 140 (S1-1), and a step of forming the base coating 160 prior to forming the clear coating 150 and after depositing the deposition layer 140 (S2-1).

The inventive injection-molded product having a multilayer pattern and the inventive method of fabricating the same which have been described above are not limited to the above-mentioned embodiments and drawings. For example, although the drawings show that the dual-level layer protrudes once from the main layer, or the dual-level layer is recessed on a protrusion of the main layer, the dual-level layer may variously protrude, or the dual-level layer may further protrude from a protrusion of the main layer.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An injection-molded product having a multilayer pattern, comprising:
a main layer formed on the injection-molded product, the main layer either protruding from or being recessed on a surface of the injection-molded layer to form a base pattern;
a dual-level layer formed on the main layer, the dual-layer including at least one layer part either protruding from or being recessed on the main layer to provide a cubic effect and a gripping sense for the main layer;
a deposition layer deposited on the surface of the injection-molded product so as to implement a color sense for the injection-molded product; and
a clear coating applied to the deposition layer so as to protect the surface of the injection-molded product and the deposition layer.

2. The injection-molded product as claimed in claim 1, wherein the main layer is formed on the surface of the injection-molded surface using at least one of NC discharge, etching, laser, and sand paper.

3. The injection-molded product as claimed in claim 1, wherein the dual-level layer is formed on the top of the main layer using at least one of NC discharge, etching, laser, and sand paper.

4. The injection-molded product as claimed in claim 1, wherein the dual-level layer comprises:
a protrusion layer part including one or more protrusions protruding from the main layer; and
a recess layer part including one or more recesses recessed in different depths on the main layer.

5. The injection-molded product as claimed in claim 1, wherein the deposition layer is formed by a metal film which is formed by depositing a metal material containing at least one of tin, silicon, titanium, aluminum, chrome, and stainless steel, and wherein the metal film is deposited at a thickness in the range of 0.01 to 0.1 μm on the surface of the injection-molded product.

6. The injection-molded product as claimed in claim 1, wherein the clear coating is coated at a thickness in the range of 15 to 20 μm.

7. The injection-molded product as claimed in claim 1, wherein a base coating is coated at a thickness in the range of 5 to 15 μm between the deposition layer and the clear coating, the base coating increasing the luminescence of the deposition layer and providing a color sense for the deposition layer.

8. The injection-molded product as claimed in claim 1, wherein the surface of the injection-molded product is pre-processed prior to depositing the deposition layer, thereby providing a pre-processed surface part, and wherein one of nitrogen gas, oxygen gas and argon gas is used for pre-processing the surface of the injection-molded product.

9. The injection-molded product as claimed in claim 8, wherein a base coating is coated at a thickness in the range of 5 to 15 μm between the deposition layer and the clear coating, the base coating increasing the luminescence of the deposition layer and providing a color sense for the deposition layer.

10. A method for fabricating an injection-molded product having a multilayer pattern, comprising:
forming a main layer and a dual-level layer, the main layer either protruding from or being recessed on a surface of the injection-molded layer to form a base pattern, and the dual-level layer being formed on the top of the main layer in such a manner that the dual-level layer includes at least one layer part either protruding from or is recessed on the main layer, thereby providing a cubic effect and a gripping sense for the main layer;
forming a deposition layer by depositing a metal material on the surface of the injection-molded product; and
applying a clear coating to the top of the deposition layer, the clear coating being adapted to protect the surface of the injection-molded product and the deposition layer.

11. The method as claimed in claim 10, wherein the main layer is formed on the surface of the injection-molded surface using at least one of NC discharge, etching, laser, and sand paper, and wherein the dual-level layer is formed on the top of the main layer using at least one of NC discharge, etching, laser, and sand paper.

12. The method as claimed in claim 10, wherein the dual-level layer comprises:
a protrusion layer part including one or more protrusions protruding from the main layer; and
a recess layer part including one or more recesses recessed in different depths on the main layer.

13. The method as claimed in claim 10, wherein the deposition layer is formed by a metal film which is formed by depositing a metal material containing at least one of tin, silicon, titanium, aluminum, chrome, and stainless steel, and wherein the metal film is deposited at a thickness in the range of 0.01 to 0.1 μm on the surface of the injection-molded product.

14. The method as claimed in claim 10, wherein the clear coating is coated at a thickness in the range of 15 to 20 μm.

15. The method as claimed in claim 10, further comprising forming a base coating on the top of the deposition layer after depositing the deposition layer, the base coating increasing the luminescence of the deposition layer and providing a color sense for the deposition layer, wherein the base coating is coated at a thickness in the range of 5 to 10 μm between the deposition layer and the clear coating.

16. The method as claimed in claim 10, further comprising pre-processing the surface of the injection-molded product prior to depositing the deposition layer, thereby providing a pre-processed surface part, wherein one of nitrogen gas, oxygen gas and argon gas is used for pre-processing the surface of the injection-molded product.

17. The method as claimed in claim 16, further comprising forming a base coating on the top of the deposition layer after depositing the deposition layer, the base coating increasing the luminescence of the deposition layer, and providing a color sense for the deposition layer, wherein the base coating is coated at a thickness in the range of 5 to 10 μm between the deposition layer and the clear coating.
